(19) United States
(12) Patent Application Publication
(10) Pub. No.: US 2015/0068976 A1
(43) Pub. Date: Mar. 12, 2015

(54) PROCESS FOR TREATING AN EFFLUENT FOR THE PURPOSE OF BRINGING DOWN THE PHOSPHATE CONTENT THEREOF, COMPRISING A STEP OF OPTIMIZED WET HEAT TREATMENT, AND CORRESPONDING EQUIPMENT

(71) Applicant: Veolia Water Solutions & Technologies Support, Saint-Maurice Cedex (FR)

(72) Inventors: Romain Lemaire, Paris (FR); Julien Chauzy, Antony (FR); Malik Djafer, Boulogne-Billancourt (FR)

(73) Assignee: VEOLIA WATER SOLUTIONS & TECHNOLOGIES SUPPORT, Saint-Maurice Cedex (FR)

(21) Appl. No.: 14/374,625

(22) PCT Filed: Jan. 25, 2013
(86) PCT No.: PCT/EP2013/051469

§ 371 Date: Oct. 1, 2014

(30) Foreign Application Priority Data
Jan. 27, 2012 (FR) 1250822
Jan. 25, 2013 (EP) PCT/EP2013/051469

(51) Int. Cl. C02F 3/30; C02F 1/72

(52) U.S. Cl. CPC C02F 3/308; C02F 1/725; C02F 2101/105
USPC 210/605; 210/181

(57) ABSTRACT

The invention pertains to a method for treating an effluent to be treated in order to reduce its phosphates content, said method comprising a step of anoxic biological treatment of said effluent to be treated, producing a first effluent, a step of aerobic biological treatment of said first effluent, producing a second effluent, a step of recirculating at least a part of said second effluent to the inlet of said anoxic biological treatment step, a step of liquid/solid separation of at least a part of said second effluent, producing a treated effluent and a first denser effluent, a step for producing volatile fatty acids including a wet heat treatment, at a temperature of 100° C. to 350° C., for a residence time of between 10 and 180 minutes, of at least a part of said first denser effluent, a step of anaerobic biological treatment of at least a part of the effluent coming from said wet heat treatment step, and a step of recirculating at least a part of the effluent coming from said anaerobic biological treatment step to the inlet of said anoxic biological treatment step.

This application is a U.S. National Stage Application of PCT Application No. PCT/EP2013/051469, with an international filing date of 25 Jan. 2013. Applicant claims priority based on French Patent Application No. 1250822 filed 27 Jan. 2012. The subject matter of these applications is incorporated herein.

### 1. FIELD OF THE INVENTION

The field of the invention is that of methods and plants for treating effluents by biological process and purification sludges obtained by the biological treatment of the effluents.

The invention especially pertains to the methods for treating waste water in order to reduce its phosphates content.

### 2. PRIOR ART

For many years now, techniques for treating waste water, for example municipal waste water, have been developed and implemented with the goal of discarding sanitized waste water into the natural environment.

These modes of treatment are aimed especially at reducing the content in nutrients, especially nitrogen and phosphorus, of the waste water before it is released into natural surroundings.

The techniques implemented for this purpose include modes of treatment by biological processes in which the water to be treated is put into contact with microorganisms which use carbon, nitrogen and phosphorous to develop in removing these elements from the waste water to be treated.

A technique known as biological dephosphatation has thus been devised to reduce the phosphates content of waste water.

This technique consists firstly in keeping the waste water under anaerobic conditions. Thus the growth is promoted therein of PAO (polyphosphate-accumulating organisms) which, in these conditions, consume volatile fatty acids (VFAs) to store carbon in polymer form and release phosphates into the effluent. The VFAs chiefly used by the PAOs to carry out the biological dephosphatation are short-carbon-chain VFAs such as acetate and propionate. The polymers stored by the PAOs are polyhydroxylalkanoates known as PHAs. This phosphate-enriched effluent is then conveyed to an aerated zone so that the PAO microorganisms can consume the phosphates previously released by using the carbon previously stored in the PAOs in the form of PHA polymers. During this phase, the PAOs consume more phosphates than they release in anaerobic conditions. It is thus possible to substantially reduce the quantity of phosphates present in the water to be treated. The effluent thus treated is sent to a liquid/solid separator from which a treated effluent and a denser effluent, in this case sludge, are extracted. This denser effluent is partially recycled at the inlet to the anaerobic zone and partly extracted from the system for treating water.

This technique of biological dephosphatation is valuable inasmuch as it enables substantial reduction of the phosphate content of waste water. However, it has drawbacks.

### 3. DRAWBACKS OF THE PRIOR ART

In order to obtain a major reduction of the phosphates content of the effluent to be treated, the PAOs must first consume a substantial quantity of VFAs in order to constitute a sufficiently high stock of PHA in anaerobic phase to be able to over-assimilate the phosphates during the next aerated phase, i.e. to assimilate more phosphates than it has previously released and thus enable a major reduction of phosphates.

However, municipal waste water generally contains an excessively small quantity of VFAs so that carrying out biological dephosphatation eliminates a limited quantity of phosphates and therefore does not eliminate as much of phosphates as is required.

To cope with this lack, it is necessary to carry out complementary physical/chemical treatment operations to eliminate the phosphates. Reagents are then often injected into the effluent to be treated. These reagents are especially metal salts (ferrous chloride or aluminum sulfate preferably). They are injected so as to precipitate phosphates and ensure satisfactory treatment. While resorting to the use of such reagents has the advantage of appropriately reducing the phosphates, it nevertheless has the drawbacks of amounting to a major cost item, increasing the quantity of sludges formed during the treatment of the water and having a negative environmental impact in terms of carbon footprint.

Other solutions have been implemented to suitably reduce the phosphates present in the water to be treated. There are known ways, for example, of implementing an anaerobic contact zone in which the effluent to be treated is introduced preliminarily so as to produce VFAs by fermentation of the carbon present in the raw water. There are also known ways of implementing means to ferment the sludges coming from the water treatment system in order to produce VFAs which are then sent to the anaerobic zone for the biological activity of the PAOs.

Implementing these techniques does indeed enable the introduction of more VFAs into the effluents to be treated and thus makes it possible to foster the development of PAOs and reduce phosphates.

These techniques nevertheless have the drawback of involving the use of additional, bulky and costly technical means dedicated solely to the production of

VFAs and to improving the reduction of phosphates without, as it happens, producing any other beneficial effect in the treatment of the effluent to be treated.

### 4. GOALS OF THE INVENTION

The invention is aimed especially at overcoming these drawbacks of the prior art.

More specifically, it is a goal of the invention, in at least one embodiment, to provide a technique for treating water that improves the reduction of phosphates by biological process while at the same time improving the overall process for treating water on at least one other plane

In particular, the invention, in at least one embodiment, pursues the goal of providing a technique of this kind that can be used to produce a large quantity of VFAs to improve the reduction of phosphates by biological means while at the same time improving the overall process for treating water on at least one other plane.

It is yet another goal of the invention, in at least one embodiment, to procure a technique of this kind that contributes to reducing or even doing away with the consumption of reagents normally used for the elimination, by physical/chemical means, of the phosphates from a water to be treated while at the same time keeping the same performance levels of treatment.

The invention, in at least one embodiment, is also aimed at providing a technique of this kind that makes it possible to reduce the quantity of sludge generated by the treatment of water.

The invention, in at least one embodiment, is also aimed at obtaining a technique of this kind that can be used to treat the sludges generated by the treatment of water in order to greatly reduce its final volume.

It is another goal of the invention, in at least one embodiment, to provide a technique of this kind that is reliable and/or relatively economical and/or simple to implement and/or can be implemented in a compact space.

### 5. SUMMARY OF THE INVENTION

These goals as well as others that shall appear here below are attained by means of a method for treating an effluent to be treated with a view to reducing its phosphates content, said method comprising an anoxic biological treatment step of said effluent to be treated producing a first effluent, an aerobic biological treatment step of said first effluent producing a second effluent, a recirculation step of least a part of said second effluent at the inlet to said anoxic biological treatment step, a liquid/solid separation step of at least a part of said second effluent producing a treated effluent and a first denser effluent, a step for producing volatile fatty acids comprising a wet heat treatment at a temperature of 100° C. to 350° C., during a residence time of 10 to 180 minutes of at least a part of said first denser effluent, an anaerobic biological treatment step of at least a part of the effluent coming from said wet heat treatment step, and a recirculation step of at least a part of the effluent coming from said anaerobic biological treatment step at the inlet to said anoxic biological treatment step.

As understood in the invention, the wet heat treatment may or may not include an injection of oxygen. The wet heat treatment can more particularly be a wet oxidation (WO) with injection of oxygen which is an intense oxidation of the organic matter contained in solutions having a high concentration of organic matter that has low biodegradability or is non-biodegradable. This wet oxidation has been implemented chiefly in the context of the treatment of industrial effluents and consists in placing an oxidizing gas in contact with said solution at high temperature while at the same time keeping the solution in a liquid state. To this end, the conditions for implementing such a method classically comprise the following ranges of values: pressure of about 1 bar to about 160 bars, temperature of about 100° C. to about 350° C. The wet heat treatment can also be a thermal hydrolysis (TH) without injection of oxygen, which makes it possible to solubilize a part of the particular organic matter contained in the sludges and thus reduce the quantity of particular organic matter to be removed. To this end, the conditions of implementing the method classically comprise the following ranges: pressure of about 1 bar to about 160 bars; temperature of about 100° C. to about 350° C.

Thus, the invention relies on a wholly original approach which consists in implementing a wet heat treatment of sludges produced during the biological treatment of waste water, under conditions of temperature and for residence times chosen so as to promote the production of VFAs therein.

The inventors have indeed observed that the fact of implementing wet heat treatment in the ranges of temperature and residence times claimed have led to the formation of a very large quantity of VFAs.

It is thus possible to achieve optimized mastery over the progress of the wet heat treatment so as to produce VFAs in large quantities and control the composition of the VFAs producing in giving preference to the VFAs used during biological dephosphatation, namely especially acetate and propionate. This is especially valuable in the case of the treatment of water involving an elimination by biological means of the phosphates which necessitate require an input of VFAs of the acetate and propionate type in order to be efficiently implemented.

The sludges produced by the biological treatment of waste water are thus treated by wet heat treatment in these special conditions so as to produce an effluent containing a large quantity of VFAs, preferably in the form of acetate and propionate which are used, by preference, by the micro-organisms responsible for biological dephosphatation.

This effluent is then introduced into the anaerobic biological treatment zone in which the development of PAOs is very extensively promoted and where the phosphates are released into the water (“de-stocking” step). A very large quantity of phosphates, greater than that released in the aerobic stage, will then be consumed subsequently by these PAOs (the over-assimilation step) when they are placed in aerobic conditions during a subsequent phase of biological treatment.

This technique does not only improve the reduction of the phosphates without requiring the use of chemical reagents or at least in limiting the consumption of reagents needed for the elimination of the phosphates if necessary during an additional physical/chemical treatment. It also reduces the sludges at the exit from the biological treatment of the water, the production of physical/chemical sludges being smaller or even zero owing to the non-use or lower consumption of chemical reagents. Finally, it enables the treatment of the sludges generated by the treatment of water in order to greatly reduce its final volume and form VFAs.

The technique according to the invention therefore leads to implementing complementary means making it possible, all at the same time, to produce VFAs used by preference by the PAOs (such as acetate and propionate) during the biological dephosphatation, reduce the quantity of reagents necessary in the event of the complementary physical/chemical dephosphatation treatment and the quantity of physical/chemical sludges produced by the use of these reagents, and reduce the overall quantity of sludge generated by the biological treatment through the wet heat treatment.

Preferably, said step for wet heat treatment is conducted at a temperature of 150 to 300° C.

Preferably, said wet heat treatment step is conducted for a residence time of 20 to 90 minutes.

Such values of temperature and of residence times favor the production of VFAs by wet heat treatment, essentially VGAs in the form of acetate and propionate which are forms preferably used during biological dephosphatation.

According to an advantageous characteristic, said wet heat treatment step comprises a wet oxidation, this process being optionally conducted in the presence of a metal catalyst such as copper or iron, taken as non-exhaustive examples.

Under certain conditions of temperature and residence times, and depending on the residence times, the use of catalysts can enable the formation during wet oxidation of VFAs usable by the biological dephosphatation.

According to an advantageous embodiment, a method according the invention comprises an anaerobic biological treatment step of said effluent to be treated prior to said anoxic biological treatment step.

According to another advantageous embodiment, a method according to the invention comprises a step for directly conveying said effluent to be treated to said anoxic biological treatment step.

In this case, the water to be treated undergoes no anaerobic biological treatment step prior to the anoxic biological treatment step. This reduces the size of the anaerobic tank used to carry out the anaerobic biological treatment.

According to one particular embodiment, said wet heat treatment step is preceded by a anaerobic digestion step.

This implementation enables the production of biogas by partly degrading the sludges formed during the biological treatment of the water. The use of such an anaerobic treatment step prior to the wet heat treatment step partly reduces the volatile matter contained in the cleansing sludges separated from the water treated during the liquid/solid separation. This makes it possible firstly to reduce the size of the plant for wet heat treatment which is linked to the quantity of volatile matter to be treated and secondly, when the wet heat treatment is an wet oxidation, to reduce the quantity of oxygen or air used (the oxygen or air being injected proportionally to the quantity of volatile matter in the sludge) and hence the costs of procuring and/or injecting oxygen or air.

According to one particular embodiment, said anaerobic biological treatment step is followed by a liquid/solid separation step producing a second clarified effluent and a second denser effluent, said second denser effluent being recirculated to the inlet to said anoxic biological treatment step, said method further comprising a biological reduction of ammoniacal nitrogen step of at least a part of said second clarified effluent and a recirculation step of the effluent coming from said biological reduction of ammoniacal nitrogen step at the inlet to said anoxic biological treatment step.

The biological reduction of ammoniacal nitrogen step will preferably be one of low consumption of organic carbon such as the nitritation/denitritation or nitritation/anammox type treatments.

A nitritation/denitritation type method consists of the introduction of a water to be treated into a biological reactor within which aerated and anoxic phases are implemented in operational conditions providing a selective pressure for the development of the AOB (ammonia oxidizing bacteria) to the detriment of the NOB (nitrite oxidizing bacteria). These operational conditions can be a high ammonium concentration (NH₄⁺), a low concentration in dissolved oxygen during the aerated phases, temperature greater than 28° C., low sludge age or several operational conditions combined. During the aerated phases, the preferential growth of AOB type bacteria to the detriment of the NOB type bacteria oxidizes the ammoniacal nitrogen (NH₄⁺) to form nitrites (NO₂⁻). The production of nitrates from nitrites by the NOB biomass is thus limited.

During the anoxic phases, the heterotrophic biomass essentially has the role of converting nitrites into molecular nitrogen, the nitrates content being low.

One nitritation/anammox type method consists in introducing water to be treated into a biological reactor within which aerated and anoxic phases are implemented, possibly simultaneously, when the concentration in dissolved oxygen is low, in minimizing the formation of nitrates by selective operational conditions and implementing a specific biomass called an “anammox” biomass.

During the aerated phases, the implementing of the same operational conditions as those described earlier for the nitritation/denitritation type method enables the selection of the AOB bacteria to the detriment of the NOB bacteria and minimizes the production of nitrates from nitrites by the NOB biomass.

During the anoxic phases, anammox type bacteria develop and act on the ammonium ions and on the nitrites to form molecular nitrogen gas (N₂) as well as a small quantity of nitrates without consuming any organic carbon since these are autotrophic bacteria, unlike the heterotrophic biomass responsible for the denitritation step in the nitritation/denitritation type method.

When the denitritation step, consisting of the degradation of the nitrites into the molecular nitrogen gas (N₂) form involves anammox type bacteria, this step known as denitritation is more specifically called an anammox step.

The second clarified effluent contains high concentrations of ammoniacal nitrogen but is impoverished in organic carbon because of the previous anaerobic biological treatment step which has consumed the greatest part of the VFAs produced by the wet heat treatment. This carbon deficit therefore cannot be used to eliminate nitrogen from this second clarified effluent by the classic methods of nitrification/denitrification without resorting to a major dosage of external carbon sources of the methanol type for example. The mixture of this second clarified effluent, rich in ammoniacal nitrogen and impoverished in carbon directly with the incoming water to be treated would also require major inputs of external carbon sources in the anoxic zone in order to enable the denitrification of all the nitrates that are produced in the aerated zone during the nitrification of large quantities of ammoniacal nitrogen and recycled in the anoxic zone. By contrast, the setting up of specific nitritation/denitritation or nitritation/anammox type low-carbon-consuming treatment of the nitrogen on at least one part of this second clarified effluent prevents or at least significantly reduces costly inputs of external carbon sources. Furthermore, the setting up of these low-carbon-consuming biological treatments of nitrogen are facilitated by the advantageous conditions of high temperature of the second clarified effluent as well as the high concentrations of ammoniacal nitrogen, these conditions being no longer valid after the mixing of the second effluent with the water to be treated.

According to one particular embodiment, said biological reduction step of ammoniacal nitrogen is advantageously preceded by a precipitation of the phosphates step.

The implementing of such precipitation enables the physical/chemical treatment of the phosphates released during the anaerobic step, for example in order to produce struvite. The struvite can be subsequently used as fertilizer and the phosphates can thus be valorized. The anaerobic step optimizes the releasing of the phosphates making the production of struvite optimal on the clarified effluent. The dense effluent containing the biological dephosphatation sludges recirculated in the anoxic zone is then available to over-assimilate the phosphates in the water to be treated during the aerated phase.

According to an advantageous characteristic, said step for wet heat treatment and/or said digestion step are preceded by a concentration (or thickening) step.

If an operation of digestion is not implemented, the wet heat treatment process could be preceded by a concentration step. Should a digestion be implemented, the digestion could be preceded by a concentration step and the wet heat treatment could furthermore be optionally preceded by a concentration step.

This reduces the volume of the sludge generated by the biological treatment of the effluent to be treated and/or the volume of the sludge generated by the anaerobic digestion. The size of the apparatuses implemented downstream to treat these sludges can thus be reduced.

According to another advantageous characteristic, said step for wet heat treatment is followed by a dehydration step producing a dehydration juice and residual sludges, said dehydration juice being sent towards said anaerobic biological treatment step.

This implementation on the one hand reduces the volume of residual sludges in solid state to be removed from the method after the wet heat treatment and on the other hand isolates the VFAs in liquid phase in the juice for recycling it according to the method.

The invention also pertains to a plant for treating an effluent by implementing a method according to any one of the variants described here above.

In one particular embodiment, such a plant comprises means for conveying an effluent to be treated, anoxic biological treatment means communicating with aerobic biological treatment means, recirculating means of at least a portion of the content of said aerobic biological treatment means in said anoxic biological treatment means, first liquid/solid separation means of at least one part of the content of said aerobic biological treatment means, recovering means of a treated effluent coming from said first liquid/solid separation means, extracting means of a first denser effluent coming from said first liquid/solid separation means, wet heat treatment means of at least one part of said denser first effluent, anaerobic biological treatment means of at least one part of the effluent coming from said wet heat treatment means, recirculation means of at least one part of the effluent coming from said anaerobic biological treatment means in said anoxic biological treatment means, said means for conveying an effluent to be treated opening into said anoxic biological treatment means or into said aerobic biological treatment means.

In one advantageous variant, a plant according to the invention comprises anaerobic digestion means upstream to said wet heat treatment means.

In another advantageous variant, a plant according to the invention comprises second liquid/solid separation means of the effluent coming from the anaerobic biological treatment means, recirculation means, in said anoxic biological treatment means, of a second denser effluent coming from said second liquid/solid separation means, biological reduction means of the ammoniacal nitrogen from an effluent coming from said first liquid/solid separation means, recirculation means of an effluent coming from said biological reduction means of the ammoniacal nitrogen in said anoxic biological treatment means.

A plant according to the invention, in this case, preferably comprises precipitation means of the phosphates placed upstream to said biological reduction means of ammoniacal nitrogen.

According to one advantageous variant, said wet heat treatment means and/or said anaerobic digestion means are preceded by concentration means.

According to another advantageous variant, said wet heat treatment means are followed by dehydration means producing a dehydration juice, said plant comprising means for conveying said dehydration juice into said anaerobic biological treatment means.

### 6. LIST OF FIGURES

Other features and characteristics of the invention shall appear more clearly from the following description of preferred embodiments, given by way of simple, illustratory and non-exhaustive examples, and from the appended drawings, of which:

FIG. 1 illustrates a plant for treating water according to a first embodiment of the invention;

FIG. 2 illustrates a plant for treating water according to a second embodiment of the invention;

FIG. 3 illustrates a plant for treating water according to a third embodiment of the invention;

FIG. 4 illustrates a plant for treating water according to a fourth embodiment of the invention;

FIG. 5 illustrates a plant for treating water according to a fifth embodiment of the invention.

### 7. DESCRIPTION OF ONE EMBODIMENT OF THE INVENTION

### 7.1. Reminder of the General Principle of the Invention

The general principle of the invention consists in implementing a wet heat treatment under conditions of temperature and according to residence times chosen so as to promote therein the development of VFAs, sludges produced during the biological treatment of water to be treated alternating with anoxic and aerobic phases. The VFA-rich effluent then undergoes an anaerobic biological treatment step during which the PAOs release a substantial quantity of phosphates which are then over-assimilated during the subsequent aerobic biological treatment.

It is thus possible to have full control over the progress of a wet heat treatment so as to produce VFAs in large quantities and in preferred forms (such as acetate and propionate for example), which are introduced into a method of biological dephosphatation to improve the reduction of phosphates and limit the use of chemical reagents.

### 7.2. Example of a First Embodiment of the Invention

7.2.1. Plant

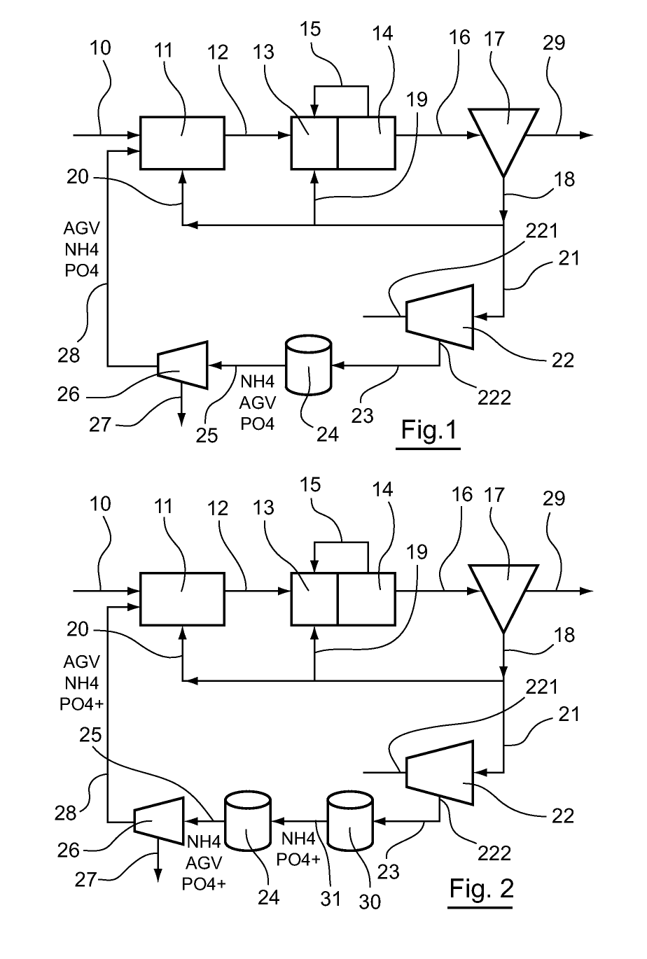

Referring to FIG. 1, we present an embodiment of a plant for treating water according to the invention.

Thus, as represented in this figure, such a plant comprises a pipe 10 for conveying water to be treated. This pipe 10 leads into the inlet of an anaerobic biological treatment zone 11.

This anaerobic biological treatment zone 11 comprises a biological reactor within which dephosphating PAO microorganisms develop when anaerobic conditions are maintained. This treatment zone 11 comprises an outlet which is connected by means of a pipe 12 to the inlet of an anoxic biological treatment zone 13.

An anoxic biological treatment zone 13 comprises a biological reactor within which denitrifying microorganisms develop when anoxic conditions are maintained. This anoxic biological treatment zone 13 comprises an outlet which is connected to the inlet of an aerobic biological treatment zone 14.

This aerobic biological treatment zone 14 comprises a biological reactor within which nitrifying microorganisms develop when the aerobic conditions are maintained. This reactor houses aeration means such as an air or oxygen blower. This aerobic biological treatment zone 14 comprises a first outlet which is connected via a recirculation pipe 15 to the anoxic biological treatment zone 13. It also comprises as second outlet which is connected via a pipe 16 to the inlet of liquid/solid separation means which in this embodiment comprise a settling tank 17. The liquid/solid separation means can also be for example membranes that are submerged or not submerged, screens, filters known as disk filters.

The settling tank 17 comprises an overflow element to which there is connected a pipe for extracting treated effluent 29. It furthermore comprises an underflow element to which there is connected a pipe for extracting a denser effluent 18, in this case decantation sludges.

The extraction pipe 18 is connected to a recirculation pipe 19 which leads into an anoxic biological treatment zone 13 and a recirculation pipe 20 which leads into the anaerobic biological treatment zone 11.

The pipe 18 is also connected to a pipe 21 which leads into an inlet of a concentrator 22 such as a gravity thickener or a mechanically operated thickener such as a centrifuge for example.

The concentrator 22 comprises two outlets: an overflow outlet 221 which returns to the top of the cleansing station and an outlet of a concentrated effluent 222 which is connected via a pipe 23 to the inlet of a wet heat treatment unit 24.

The wet heat treatment unit 24 comprises an outlet which is connected by a pipe 25 to the inlet of a dehydrator 26.

The dehydrator comprises an outlet of dehydrated matter connected to an extraction pipe 27. It also comprises a dehydration juices outlet which is connected via a pipe 28 to the inlet of the anaerobic biological treatment zone 11.

7.2.2. Method

An example of a method according to the invention implementing a plant described with reference to FIG. 1 is now described.

Such a method consists in conveying water to be treated, for example municipal waste water, into the biological treatment zone 11 via the inlet pipe 10.

An anaerobic environment is maintained in the biological treatment zone 11. The development of a PAO dephosphating biomass is thus promoted therein. Under anaerobic conditions, this biomass consumes and stores the VFAs contained in the water to be treated in the form of PHA and releases phosphates.

The phosphate-enriched water is then conveyed via the pipe 12 into the biological treatment zone 13.

An anoxic environment is maintained in the biological treatment zone 13. The development of a denitrifying biomass is thus fostered therein. Under anoxic conditions and in the presence of a source of organic carbon, this biomass degrades the nitrates contained in the water to be treated into diazote or molecular nitrogen gas. The water then undergoes a denitrification.

The water coming from the treatment zone 13 is then introduced into the biological treatment zone 14.

An aerobic environment is maintained in the biological treatment zone 14. The development of a nitrifying biomass is thus fostered therein. Under aerobic conditions, this biomass degrades the ammoniacal nitrogen contained in the water to be treated into nitrates. The water then undergoes a nitrification.

Under aerobic conditions, the PAOs assimilate the phosphates previously released in the anaerobic zone 11 and consume a part of the organic carbon previously stored in the form of PHAs in the anaerobic zone 11. The quantity of phosphates assimilated by the PAOs during the sub-aerobic phase is far greater than that released during the anaerobic phase. The quantity of phosphates initially contained in the water to be treated is thus reduced.

The water of the treatment zone 14 is partly recycled via the pipe 15 into the treatment zone 13 so that the nitrates formed during the nitrification in the aerobic treatment zone 14 are degraded into diazote or molecular nitrogen by nitrification in the anoxic treatment zone 13.

The remainder of the water of the treatment zone 14 is conveyed via the pipe 16 to the settling tank 17 to undergo a liquid/solid separation therein. The liquid/solid separation means can also for example be membranes that are submerged or not submerged, screens, filters known as disk filters. Clarified treated water is extracted in an overflow from the settling tank 17 via the extraction pipe 29. A denser effluent, in this case constituted by decanted biological sludges, is extracted in an underflow via the pipe 18.

In this embodiment, these sludges are partly recirculated in the anoxic treatment zone 13 via the pipe 19 and/or into the anaerobic treatment zone 11 via the pipe 20. The sludges containing all the species of biomass responsible for the depollution of waste water are thus recirculated and reutilized.

The remainder of these sludges are conveyed via the pipe 21 to the inlet of the concentrator 22.

The concentrated sludges are removed from the concentrator 22 and conveyed by the pipe 23 into the wet heat treatment unit 24.

The sludges therein are treated by wet heat treatment at a temperature of 100 to 350° C., for a residence time ranging from 10 to 180 minutes, and advantageously in the presence of a metal catalyst such as copper or iron should the wet heat treatment be a wet oxidation treatment.

The implementing of this wet heat treatment in such conditions fosters the formation of a large quantity of VFAs. The effluents coming out of the wet heat treatment zone 24 then contain VFAs, ammoniacal nitrogen and phosphates. These effluents are introduced via the pipe 25 into the dehydrator 26.

The dehydrated mineral matter is extracted from the dehydrator 26 through the pipe 27 while a dehydration juice is extracted therefrom via the pipe 28. This dehydration juice contains VFAs, ammoniacal nitrogen and phosphates. It is recirculated in the anaerobic biological treatment zone 11.

The introduction of a large quantity of VFA into the zone 11 via the pipe 28 therein fosters the development and activity of the PAOs.

Since:
the elimination of the phosphates during the aerobic phase by PAOs is all the higher as the development of the PAOs during the anaerobic phase is great and is facilitated by the substantial presence of VFA, and
since the assimilation of the phosphates by the PAOs during the aerobic phase is far greater than its release during the anaerobic phase,
   the implementing of the technique according to the invention significantly reduces the concentration in phosphates of the waste water to be treated without requiring the use of dephosphating chemical reagents, or at least significantly diminishes their use.

Furthermore, the technique of the invention greatly reduces the quantity of sludge formed during treatment of the water because:
the production of the physical-chemical sludge is lower or even zero owing to the non-use or lesser use of the chemical reagents;
the wet heat treatment greatly reduces the volume of produced sludges to be treated while at the same time forming the VFAs needed to optimize biological dephosphatation.

### 7.3. Example of a Second Embodiment of the Invention

7.3.1. Plant

Referring to FIG. 2, we present a plant according to a second embodiment.

The plant illustrated in FIG. 2 is distinguished from the one illustrated in FIG. 1 by the fact that it comprises in addition an anaerobic digester 30 interposed between the outlet of the concentrator 22 and the inlet of the wet heat treatment 24, to the inlet of which it is connected by means of a pipe 31.

7.3.2. Method

An example of a method according to the invention implementing a plant described with reference to FIG. 2 is now described.

Such a method is distinguished from the one described here above by the fact that the concentrated sludges coming from the concentrator 22 are conveyed via the pipe 23 to the anaerobic digester 30.

These sludges therein undergo an anaerobic digestion which leads to the formation and extraction of biogas and a sludge containing residual organic matter, ammoniacal nitrogen and phosphates. This sludge is introduced via the pipe 31 into the wet heat treatment zone 24 within which the residual organic matter is degraded to form VFAs. The rest of the method is identical to the previous one.

The implementing of the anaerobic digestion prior to wet heat treatment partly reduces the volatile matter contained in the cleansing sludges and provides two advantages. Firstly, it reduces the size of the wet heat plant which is related to the quantity of volatile matter to be treated, and secondly, when the wet heat treatment is wet oxidation, it reduces the quantity of oxygen or air used (the oxygen or air being injected in proportion to the quantity of volatile matter in the sludge) and therefore the costs of procuring supplies and/or injecting oxygen or air.

### 7.4. Example of a Third Embodiment of the Invention

7.4.1. Plant

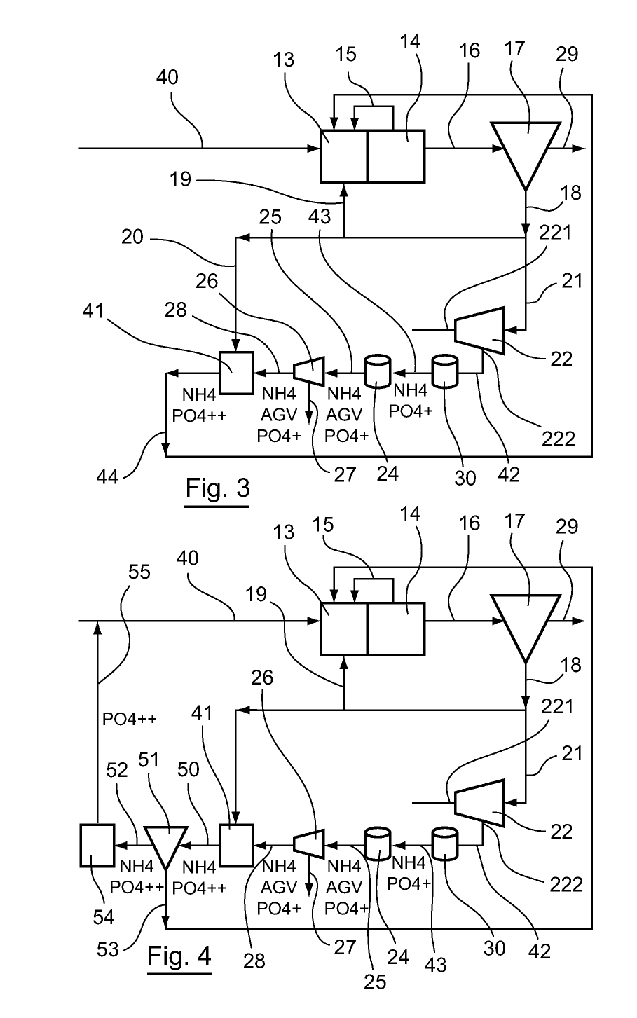

Referring to FIG. 3, we present a plant according to a third embodiment.

As shown in this FIG. 3, such a plant comprises a water inlet pipe 40. This pipe 40 leads into the inlet of an anoxic biological treatment zone 13.

This anoxic biological treatment zone 13 comprises a biological reactor within which anoxic conditions are maintained so that the development of denitrifying microorganisms is fostered. This anoxic biological treatment zone 13 comprises an outlet that is connected to the inlet of an aerobic biological treatment zone 14.

This aerobic biological treatment zone 14 comprises a biological reactor that houses aeration means such as an air or oxygen distributor, within which aerobic conditions are maintained so that the development of the nitrifying microorganisms is promoted. This aerobic biological treatment zone 14 comprises a first outlet that is linked via a recirculation pipe 15 to the anoxic biological treatment zone 13. It also comprises a second output which is linked via a pipe 16 to the inlet of the liquid/solid separation means which in this embodiment comprise a settling tank 17. The liquid/solid separation means can also for example be membranes that are submerged or not submerged, screens, filters known as disk filters.

The settling tank 17 comprises an overflow element to which there is connected a pipe 19 for extracting treated effluent. It also comprises an underflow element to which there is connected a pipe 18 for extracting denser effluent, in this case decantation sludges.

The extraction pipe 18 is connected to a recirculation pipe 19 which leads into an anoxic biological treatment zone 13 and a recirculation pipe 20 that leads into a zone of anaerobic biological treatment zone 41.

The pipe 18 is also connected to a pipe 21 which leads into the inlet of a concentrator 22 such as a gravity thickener or a mechanical thickener such as a centrifuge for example.

The concentrator 22 comprises two outlets: an overflow outlet 221 which return to the head of the cleansing station and a concentrated effluent outlet 222 which is connected via a pipe 42 to the inlet of an anaerobic digester 30.

The anaerobic digester 30 comprises an outlet that is linked by a pipe 43 to the inlet of a wet heat treatment unit 24.

The wet heat treatment unit 24 comprises an outlet that is connected by a pipe 25 to the inlet of a dehydrator 26.

The dehydrator 26 comprises an outlet of dehydrated mineral matter connected to an extraction pipe 27. It also comprises an outlet of dehydration juices which is connected via a pipe 28 to the inlet of the anaerobic biological treatment zone 41.

The anaerobic biological treatment zone 41 comprises an outlet which is connected to the pipe 44 which leads into the anoxic biological treatment zone 13.

In one variant of this embodiment, it is possible not to implement any anaerobic digester 30.

7.4.2. Method

An example of a method according to the invention implementing a plant described with reference to FIG. 3 is now described.

Such a method consists in conveying water to be treated, for example municipal waste water, into the biological treatment zone 13 via the inlet pipe 40.

An anoxic environment is maintained in the biological treatment zone 13. The development of a denitrifying biomass therein is thus promoted. Under anoxic conditions, this biomass degrades the nitrates contained in the water to be treated to form diazote or molecular nitrogen gas. The water then undergoes a denitrification.

The water coming from the treatment zone 13 is then introduced into the biological treatment zone 14.

An aerobic environment is maintained in the biological treatment zone 14. The development of a nitrifying biomass therein is thus promoted. Under aerobic conditions, this biomass degrades the ammoniacal nitrogen contained in the water to be treated to form nitrates. The water then undergoes nitrification.

Under aerobic conditions, the PAOs assimilate the phosphates by using the organic carbon stored in the form of PHAs during the anaerobic phase of the treatment zone 41. The quantity of phosphates assimilated by the PAOs during the aerobic phase is much greater than that released during the anaerobic phase: there is therefore an elimination of phosphates from the waste water.

The water from the treatment zone 14 is partly recycled via the pipe 15 into the treatment zone 13 so that the nitrates formed during the nitrification therein are degraded into diazote or molecular nitrogen by denitrification.

The remainder of the water of the treatment zone 14 is conveyed via the pipe 16 into the settling tank 17 to undergo liquid/solid separation therein. The liquid/solid separation means can also for example be membranes that are submerged or not submerged, screens, filters known as disk filters. Clarified treated water is extracted in an overflow from the settling tank 17 via the extraction pipe 29. A denser effluent, in this case constituted by decanted biological sludges, is extracted in an underflow via the pipe 18.

In this embodiment, these sludges are partly recirculated in the anoxic treatment zone 14 via the pipe 19 and/or in the anaerobic treatment zone 41 via the pipe 20. The sludges containing all the species of biomasses responsible for the depollution of the waste water are thus recirculated and reutilized.

The rest of these sludges are conveyed via the pipe 21 to the inlet of the concentrator 22.

The concentrated sludges are removed from the concentrator 22 and conveyed via the pipe 42 into the digester 30 in order to therein undergo anaerobic digestion. Biogas is then extracted from the digester 30 along with an effluent containing ammoniacal nitrogen and phosphates.

This effluent is introduced via the pipe 43 into the wet heat treatment unit 24.

The sludges are therein treated by wet heat treatment at a temperature of 100 to 350° C., for a residence time of 10 to 180 minutes and advantageously in the presence of a metal catalyst such as copper or iron when the wet heat treatment is a wet oxidation.

Implementing this wet heat treatment in such conditions promotes the formation of a large quantity of VFAs. The effluents coming out of the wet heat treatment zone 24 then contains VFAs, ammoniacal nitrogen and phosphates. These effluents are introduced via the pipe 25 into the dehydrator 26.

Dehydrated mineral matter is extracted from the dehydrator 26 via the pipe 27 while a dehydration juice is extracted therefrom via the pipe 28. This dehydration juice contains VFAs, ammoniacal nitrogen and phosphates. It is introduced into the anaerobic biological treatment zone 41.

An anaerobic environment is maintained in the biological treatment zone 41 and concentrated sludges containing PAOs are conveyed from the settling tank 17. The development and activity of a dephosphating biomass PAO is thus promoted therein. Under anaerobic conditions, this biomass consumes and stores the VFAs contained in the water to be treated in PHA form and releases phosphates.

The phosphates-enriched water is then conveyed via the pipe 44 into the biological treatment zone 13 and then into the treatment zone 14 where the phosphates are over-assimilated by the PAOs and therefore reduced in the waste water.

In one variant, it can be that the anaerobic digestion step is not implemented.

### 7.5. Example of a Fourth Embodiment of the Invention

7.5.1. Plant

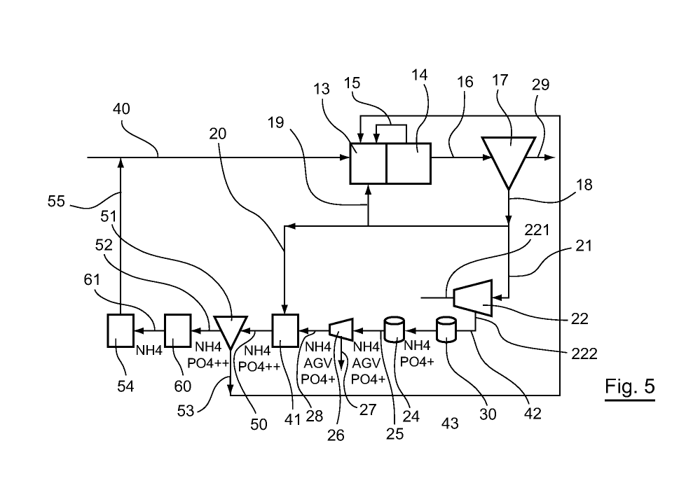

Referring to FIG. 4, a plant according to the fourth embodiment is presented.

The plant according to this fourth embodiment is distinguished from the one according to the third embodiment inasmuch as the outlet the anaerobic biological treatment zone 41 is connected by a pipe 50 to the inlet of liquid/solid separation means which, in this embodiment, comprise a settling tank 51.

The settling tank 51 comprises a first outlet which is connected to a pipe for extracting decanted effluent 52 and a second outlet which is connected to a pipe for extracting a denser effluent 53.

The pipe 53 leads into the anoxic biological treatment zone 13.

The pipe 52 leads into the inlet of an ammoniacal nitrogen biological treatment unit that consumes little organic carbon 54. In this embodiment, this treatment unit is a nitritation/denitritation or nitritation/anammox treatment unit.

The ammoniacal nitrogen biological treatment unit 54 comprises an outlet that is connected to a pipe 55 that leads into the inlet pipe 40.

It is possible, in one variant of this embodiment, not to implement an anaerobic digester 30.

7.5.2. Method

One example of a method according to the invention implementing a plant described with reference to FIG. 4 is now described.

Such a method is distinguished from the one implementing a plant according to FIG. 3 because the effluents coming from the biological treatment zone 41 are introduced therein via the pipe 50 into the settling tank 51.

A decanted effluent is extracted in an overflow from the settling tank 51 via the pipe 52 and a denser effluent is extracted therefrom in an underflow via the pipe 53. This denser effluent is recirculated via the pipe 53 into the biological treatment zone 13. The decanted effluent is introduced via the pipe 52 into the ammoniacal nitrogen biological treatment zone which consumes little organic carbon 54. It therein undergoes a nitritation/denitritation or a nitritation/anammox process.

The phosphate-rich effluents coming from the ammoniacal nitrogen biological treatment zone 54 are introduced via the pipe 55 into the inlet pipe 40.

### 7.6. Example of a Fifth Embodiment of the Invention

7.6.1. Plant

Referring to FIG. 5, we present a plant according to a fifth embodiment.

The plant according to this fifth embodiment is distinguished from the plant according to the fourth embodiment inasmuch as the pipe for extracting a decanted effluent 52 leads into a unit 60 for treatment by precipitation of the phosphates. This unit for treating phosphorous by mineral precipitation can be a crystallizer or any other type of method used to precipitate phosphates in the form of minerals such as struvite, apatite or the like that can be valorized.

The unit 60 for treatment by precipitation comprises an outlet which is connected by a pipe 61 to the inlet of the ammoniacal nitrogen biological treatment unit 54 and a pipe (not shown) extracting a denser phase containing phosphorous precipitated in the form of struvite or the like for valorization.

It is possible, in one variant of this embodiment, not to implement an anaerobic digester 30.

7.6.2. Method

An example of a method according to the invention implementing a plant described with reference to FIG. 54 is now described.

Such a method is distinguished from the one implementing a plant according to FIG. 4 by the fact that the effluents coming from the settling tank 51 are introduced via the pipe 52 into the unit 60 for treatment by precipitation.

The phosphates contained in the effluents introduced inside the unit 60 are precipitated. The advantage of this configuration is that it enables the recovery of the phosphates and makes it possible to ensure their valorization subsequently. An effluent containing ammoniacal nitrogen is then extracted from the unit 60 and introduced via the pipe 61 into the ammoniacal nitrogen biological treatment zone 54. It therein undergoes nitritation/denitritation or nitritation/anammox. The effluent is therefore impoverished in ammoniacal nitrogen.

The effluent coming from the treatment zone 54 is recirculated via the pipe 55 into the inlet 40.

### 7.7. Advantages

The technique according to the invention optimizes a wet heat treatment so as to favor the formation of VFAs.

Implementing this technique for optimizing wet heat treatment in a method of water treatment including biological dephosphatation augments the reduction by biological means of phosphates in the water to be treated while at the same time reducing or even eliminating the use of chemical reagents as a complement. Thus, the need to reduce phosphates by physical/chemical means is reduced as is the formation of sludges because this process prevents the generation of physical/chemical sludges related to the use of chemical reagents for reducing phosphates. The final volume of sludges is reduced by the action of the wet heat treatment on the sludges generated by the biological treatment method. If necessary, the production of biogas is increased. The implementing of an additional apparatus to produce VFAs and improve the biological dephosphatation is therefore not necessary since this is ensured by an apparatus fulfilling another function, namely the wet heat treatment which enables the volume of sludges to be reduced.

1-17. (canceled)

18. A method for treating an effluent to reduce the phosphates content of the effluent, said method comprising an anoxic biological treatment step of said effluent which produces a first effluent, an aerobic biological treatment step of said first effluent which produces a second effluent, a recirculating step of at least a part of said second effluent to the inlet of said anoxic biological treatment step, a liquid-solids separation step of at least a part of said second effluent which produces a treated effluent and a first denser effluent, a step for producing volatile fatty acids including a wet heat treatment, at a temperature of 100° C. to 350° C., for a residence time of between 10 and 180 minutes, of at least a part of said first denser effluent, an anaerobic biological treatment step of at least a part of the effluent coming from said wet heat treatment step, and a recirculating step of at least a part of the effluent coming from said anaerobic biological treatment step to the inlet of said anoxic biological treatment step.

19. The method according to claim 18, characterised in that said wet heat treatment step is conducted at a temperature of 150° C. to 300° C.

20. The method according to claim 18, characterised in that said wet heat treatment step is conducted for a residence time of 20 to 90 minutes.

21. The method according to claim 18, characterised in that said wet heat treatment step includes wet oxidation and is conducted in the presence of a metal catalyst.

22. The method according to claim 18, characterised in that it includes an anaerobic biological treatment step of said effluent prior to said anoxic biological treatment step.

23. The method according to claim 18, characterised in that the method includes a step for directly conveying said effluent to said anoxic biological treatment step.

24. The method according to claim 18, characterised in that said wet heat treatment step is preceded by an anaerobic digestion step.

25. The method according to claim 23, characterised in that said anaerobic biological treatment step is followed by a liquid-solids separation step producing a second clarified effluent and a second denser effluent, said second denser effluent being recirculated to the inlet of said anoxic biological treatment step; said method also including a biological treatment step of the ammoniacal nitrogen of at least a part of said second clarified effluent and a recirculating step of the effluent coming from said ammoniacal nitrogen biological treatment step to the inlet of said anoxic biological treatment step.

26. The method according to claim 25, characterised in that said ammoniacal nitrogen biological treatment step is preceded by a phosphate precipitation step.

27. The method according to claim 18, characterised in that said wet heat treatment step and/or said digestion step are preceded by a concentration step.

28. The method according to claim 18, characterised in that said wet heat treatment step is followed by a dehydration step producing a dehydration juice and residual sludge, said dehydration juice being sent to said anaerobic biological treatment step.

29. A biological process for treating an effluent and reducing the content of phosphates in the effluent, the method comprising:
(a) directing the effluent into an anoxic biological treatment unit and subjecting the effluent to biological treatment under anoxic conditions and producing a first effluent;
(b) directing the first effluent to an aerobic biological treatment and subjecting the first effluent to treatment under aerobic conditions and producing a second effluent;
(c) recirculating at least a portion of the second effluent to the anoxic biological treatment unit;
(d) directing at least portion of the second effluent to a liquid-solids separator and producing a treated effluent and a first denser effluent, that is denser than the treated effluent;
(e) producing volatile fatty acids from the first denser effluent by directing at least a portion of the first denser effluent through a wet heat treatment unit and treating the first denser effluent in the wet heat treatment unit at a temperature of 100° C.-350° C. for a residence time of 10-180 minutes and producing a wet heat treatment effluent having volatile fatty acids;
(f) directing the wet heat treatment effluent to an anaerobic biological treatment unit and subjecting the wet heat treatment effluent to biological treatment under anaerobic conditions and producing an effluent; and
(g) recirculating at least a portion of the effluent from the anaerobic treatment unit to the anoxic biological treatment unit.

30. The method of claim 29 wherein the wet heat treatment is conducted at a temperature of 150° C.-300° C. for a residence time of 20-90 minutes.

31. The method of claim 29 wherein the wet heat treatment includes a wet oxidation process conducted in the presence of a metal catalyst.

32. The method of claim 29 including directing the effluent to a second anaerobic biological treatment unit disposed upstream of the anoxic biological treatment unit wherein the effluent is subjected to biological treatment under anaerobic conditions prior to being subjected to biological treatment under anoxic conditions.

33. The method of claim 29 including directing the first denser effluent to an anaerobic digester prior to directing the first denser effluent to the wet heat treatment unit; and subjecting the first denser effluent to an anaerobic digestion process in the anaerobic digester.

34. A system for treating wastewater comprising:
an anaerobic biological treatment unit for receiving the wastewater and subjecting the wastewater to biological treatment under anaerobic conditions to produce a first effluent;
an anoxic biological unit disposed downstream from the anaerobic biological treatment unit for receiving the first effluent, subjecting the first effluent to biological treatment under anoxic conditions to produce a second effluent;
an aerobic biological treatment unit downstream of the anoxic biological treatment unit for receiving the second effluent and subjecting the second effluent to biological treatment under aerobic conditions and producing a third effluent;
a recirculation line operatively interconnected between the anoxic biological treatment unit and the aerobic biological treatment unit for recirculating wastewater from the aerobic biological treatment unit to the anoxic biological treatment unit;
a liquid-solids separator disposed downstream of the aerobic biological treatment unit for receiving the third effluent and separating the third effluent into a treated effluent and a denser effluent that is denser than the treated effluent;
a wet heat treatment unit downstream of the liquid-solids separator for receiving the denser effluent and converting at least a portion of the denser effluent to volatile fatty acids and providing a volatile fatty acid-containing effluent;
a concentrator downstream of the wet heat treatment unit for receiving the volatile fatty acid-containing effluent to produce a concentrated stream and a concentrator effluent; and
a line operatively interconnecting the concentrator and the anaerobic biological treatment unit for directing the concentrator effluent from the concentrator to the anaerobic biological treatment unit.

35. The system of claim 34 further including a second concentrator operatively interconnected between the liquid-solids separator and the wet heat treatment unit for concentrating the denser effluent prior to reaching the wet heat treatment unit.
